(19) United States
(12) Patent Application Publication
(10) Pub. No.: US 2023/0307792 A1
(43) Pub. Date: Sep. 28, 2023

(54) ELASTIC SHEET COMPOSITION FOR ALL-SOLID-STATE BATTERY, ELASTIC SHEET, AND ALL-SOLID-STATE BATTERY

(71) Applicant: SAMSUNG SDI CO., LTD., Yongin-si (KR)

(72) Inventors: Ik Hwan CHO, Yongin-si (KR); Jinhwan PARK, Yongin-si (KR); Eungyeong LEE, Yongin-si (KR); Byeongdo KWAK, Yongin-si (KR)

(21) Appl. No.: 18/105,728

(22) Filed: Feb. 3, 2023

(30) Foreign Application Priority Data
Feb. 10, 2022 (KR) 10-2022-0017781

(51) Int. Cl. H01M 50/48; H01M 50/474

(52) U.S. Cl. CPC H01M 50/48; H01M 50/474

(57) ABSTRACT

An elastic sheet composition for an all-solid-state battery includes an acrylate resin, hollow particles, and elastic particles, an elastic sheet for an all-solid-state battery prepared from the composition, and an all-solid-state battery including the elastic sheet.

### CROSS-REFERENCE TO RELATED APPLICATION

This application claims priority to and the benefit of Korean Patent Application No. 10-2022-0017781, filed in the Korean Intellectual Property Office on Feb. 10, 2022, the entire content of which is incorporated herein by reference.

### BACKGROUND

### 1. Field

Embodiments of the present disclosure described herein are related to an elastic sheet composition for an all-solid-state battery, an elastic sheet for an all-solid-state battery prepared therefrom, and an all-solid-state battery including the same.

### 2. Description of the Related Art

A portable information device such as a cell phone, a laptop, a smart phone, and/or the like or an electric vehicle has utilized a rechargeable lithium battery having relatively high energy density and easy portability as a driving power source. Recently, research has been actively conducted to utilize a rechargeable lithium battery with relatively high energy density as a driving power source or power storage power source for hybrid or electric vehicles.

Commercially available rechargeable lithium batteries utilize an electrolyte containing a flammable organic solvent and have a safety problem of explosion or fire at a collision or penetration. Accordingly, semi-solid batteries or all-solid-state batteries not utilizing the electrolyte have been proposed. An all-solid-state battery among rechargeable lithium batteries refers to a battery in which all materials are solid, and in particular, a battery utilizing a solid electrolyte. This all-solid-state battery should be safe with no risk of explosion due to leakage of the electrolyte and also easily manufactured into a thin battery.

In the all-solid-state battery, in general, a sulfide-based solid electrolyte with high ionic conductivity is utilized, wherein this sulfide-based solid electrolyte is deteriorated in air and thus needs to or should be protected from the air. Therefore, an electrode assembly including the sulfide-based solid electrolyte is inserted into a case utilizing a laminate film or a rigid material and then, sealed and pressed, manufacturing the battery. However, stress during the pressing may be transmitted to the solid electrolyte and thus break it, or as a thickness of an electrode changes according to charges and discharges, the stress is accumulated and causes a crack in the solid electrolyte, resulting in a short circuit.

In some embodiments, when not uniformly pressed from the outside during the battery discharge, lithium ions may move at a lower speed or toward a locally pressed region, deteriorating discharge efficiency. Furthermore, the non-uniform pressing may break the solid electrolyte.

Accordingly, a technique of applying an elastic sheet to the outside of the electrode assembly has been developed. However, a related art silicon-based elastic sheet has disadvantages of realizing a thin thickness and being expensive, and a polyurethane-based or rubber-based elastic sheet has an excellent or suitable restoring force but lacks stress relaxation properties, which are all limitations in realizing a long cycle-life.

### SUMMARY

Aspects of embodiments of the present disclosure are directed toward an elastic sheet composition for an all-solid-state battery, which alleviates the stress transmitted during the pressing when manufacturing the all-solid-state battery and the stress generated according to the thickness change of the battery during repeated charges and discharges and has an excellent or suitable restoring force and concurrently (e.g., simultaneously), realizes moderately or suitably high compressive strength to effectively suppress or reduce cracks of the solid electrolyte or the laminate film during the charges and discharges and thus improve charge and discharge efficiency and cycle-life characteristics of the all-solid-state battery.

Aspects of embodiments of the present disclosure are directed toward a highly stress-relaxing elastic sheet which may improve contacts of solid components through substantially uniform pressing of an electrode body but distribute the stress applied to the solid electrolyte, have an excellent or suitable restoring force during the charges and discharges to apply a substantially uniform pressure to the contact surface between the electrode and the solid electrolyte during the charges and discharges and thus to increase discharge efficiency, and reduce the stress applied to the solid electrolyte, even though a thickness of the electrode increases. Thus, an all-solid-state battery with improved coulombic efficiency and cycle-life characteristics is provided.

Additional aspects will be set forth in part in the description which follows and, in part, will be apparent from the description, or may be learned by practice of the presented embodiments of the disclosure.

According to one or more embodiments, an elastic sheet composition for an all-solid-state battery includes an acrylate resin, hollow particles, and elastic particles.

In one or more embodiments, an elastic sheet for an all-solid-state battery is manufactured from the composition.

In one or more embodiments, an all-solid-state battery includes a positive electrode, a negative electrode, a solid electrolyte layer between the positive electrode and the negative electrode, and the elastic sheet is on the outside of at least one of the positive electrode or the negative electrode.

The elastic sheet composition for an all-solid-state battery according to an embodiment and the elastic sheet prepared therefrom have high compressive strength and also, a high stress relaxation rate and a high restoring rate and thus may be configured to transmit or capable of providing substantially uniform pressure to the electrode body during the manufacturing process and the charge/discharge process of the all-solid-state battery, sufficiently alleviate the stress applied to the solid electrolyte, the electrode body, the laminate film, and/or the like and suppress or reduce cracks, resulting in improving coulombic efficiency and cycle-life characteristics of the all-solid-state battery.

### BRIEF DESCRIPTION OF THE DRAWINGS

FIGS. 1 and 2 are schematic cross-sectional views of an all-solid-state battery according to embodiments.

### DETAILED DESCRIPTION

Hereinafter, specific embodiments will be described in more detail so that those of ordinary skill in the art can easily implement them. However, this disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise.

As utilized herein, “combination thereof” refers to a mixture, stack, composite, copolymer, alloy, blend, reaction product, and/or the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout, and duplicative descriptions thereof may not be provided the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The phrase “in a plan view” refers to viewing the object portion from the top, and the phrase “in a cross-sectional view” refers to viewing a cross-section of which the object portion is vertically cut from the side.

In addition, the average particle diameter or average size may be measured by a method well suitable to those skilled in the art, for example, may be measured by a particle size analyzer, or may be measured by a transmission electron micrograph or a scanning electron micrograph. Alternatively, it is possible to obtain an average particle diameter value by measuring a size utilizing a dynamic light scattering method, performing data analysis, counting the number of particles for each particle size range, and calculating from this. Unless otherwise defined, average particle diameter refers to the diameter (D50) of particles with a cumulative volume of 50 volume% in the particle size distribution as measured by a particle size analyzer.

In the present specification, when particles are spherical, “diameter” indicates a particle diameter or an average particle diameter, and when the particles are non-spherical, the “diameter” indicates a major axis length or an average major axis length.

Further, the use of “may” when describing embodiments of the present disclosure refers to “one or more embodiments of the present disclosure.”

Spatially relative terms, such as “beneath”, “below”, “lower”, “downward”, “above”, “upper”, “left”, “right”, and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As utilized herein, the term “and/or” includes any and all combinations of one or more of the associated listed items. Throughout the disclosure, the expression “at least one of a, b or c”, “at least one of a-c”, “at least one of a to c”, “at least one of a, b, and/or c”, etc., indicates only a, only b, only c, both (e.g., simultaneously) a and b, both (e.g., simultaneously) a and c, both (e.g., simultaneously) b and c, all of a, b, and c, or variations thereof.

In the present specification, “including A or B”, “A and/or B”, etc., represents A or B, or A and B.

As used herein, the term “substantially,” “about,” and similar terms are used as terms of approximation and not as terms of degree, and are intended to account for the inherent deviations in measured or calculated values that would be recognized by those of ordinary skill in the art. “About” or “substantially”, as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” or “substantially” may mean within one or more standard deviations, or within ± 30%, 20%, 10%, 5% of the stated value.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

### All-Solid-State Battery

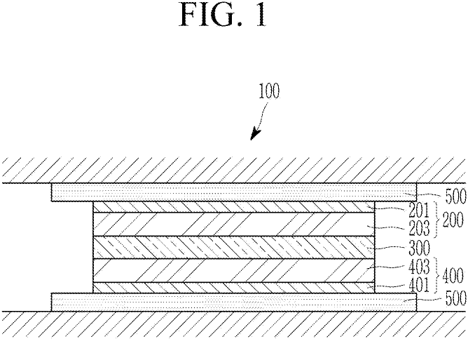

FIG. 1 is a cross-sectional view of an all-solid-state battery according to an embodiment. Referring to FIG. 1, an all-solid-state battery 100 may have a structure in which an electrode assembly in which a negative electrode 400 including a negative electrode current collector 401 and a negative active material layer 403; a solid electrolyte layer 300; a positive electrode 200 including a positive active material layer 203 and a positive electrode current collector 201; an elastic sheet 500 on the outside of at least one of the positive electrode 200 or the negative electrode 400 are stacked is accommodated in a case such as a pouch. Although one electrode assembly including the negative electrode 400, the solid electrolyte layer 300, and the positive electrode 200 is shown in FIG. 1, an all-solid-state battery may be manufactured by stacking two or more electrode assemblies.

The all-solid-state battery 100 is manufactured by pressing the electrode stack in the manufacturing process, and has a structure in which charging and discharging proceeds in a pressurized state. Herein, the elastic sheet 500 may be expressed as a buffer layer or an elastic layer. It serves to make the contact between the solid components relatively good or suitable by ensuring that the pressure is uniformly or substantially uniformly transmitted to the electrode stack, in addition, it plays a role in relieving the stress transmitted to the solid electrolyte, etc., and during charging and discharging, it can play a role in suppressing the occurrence of cracks in the solid electrolyte due to the accumulation of stress according to the change in the thickness of the electrode.

The elastic sheet 500 may be located on the outermost layer surface of the electrode assembly as shown in FIG. 1, or may be located on the outermost layer and/or inside the assembly in a structure in which two or more electrode assemblies are stacked. In consideration of the fact that the negative electrode changes greatly in thickness during charge and discharge due to dendrite formation, etc., the elastic sheet 500 is disposed on the outside of the negative electrode, that is, on the opposite (opposing) side of the surface in contact with the solid electrolyte layer at the negative electrode, thereby it may play a role of buffering the problems caused by the change in thickness. In some embodiments, because the elastic sheet 500 is on the outside of the positive electrode and/or negative electrode, deterioration caused by reaction with lithium may be prevented or reduced, and thus, an effect of increasing coulombic efficiency of the battery may be obtained.

### Elastic Sheet Composition

In an embodiment, an elastic sheet composition for an all-solid-state battery including an acrylate resin, hollow particles, and elastic particles is provided. The elastic sheet composition may be expressed as a composition for forming an elastic sheet. The elastic sheet prepared from the elastic sheet composition according to an embodiment has moderately high compressive strength in the compression direction, and at the same time, has excellent or suitable stress relaxation force and restoring force in the compression direction.

For example, when the elastic sheet has too low compressive strength and thus is soft, the elastic sheet may be compressed by about 60% or more compared to the initial thickness during the pressuring process and thus highly densified, failing in realizing compression and restoring characteristics (buffering) and resisting thickness changes of a negative electrode during the charges and discharges and thus greatly increasing the stress applied to the solid electrolyte, which lead to breakage of the solid electrolyte and resultantly, nullify performance of the battery. On the other hand, when the compressive strength of the elastic sheet is too high, density of the elastic sheet is difficult to lower, not realizing stress relaxation performance but increasing stress during repeated compressions and restorations, resulting in deteriorating charge and discharge efficiency. Accordingly, it is important to apply an elastic sheet exhibiting appropriate or suitable compressive strength to an all-solid-state battery.

However, trade-off relationship between compressive strength and stress relaxation is difficult to overcome by types (kinds) of an acrylate resin, types (kinds) of a crosslinking agent, contents thereof, and/or the like. Accordingly, in an embodiment, hollow particles are applied to increase compressive strength of the acrylate resin and realize a foam shape. In some embodiments, because a stress relaxation force and a restoring force are also in trade-off relationship, when the crosslinking agent is increased, the restoring force is increased, but the stress relaxation force is decreased. Accordingly, in an embodiment, elastic particles are applied to increase the restoring force, while maintaining the stress relaxation force of the acrylate resin.

For example, the elastic sheet according to an embodiment has density in a range of about 0.3 g/cm³ to about 0.8 g/cm³, compressive strength (CFD 40%) in a range of about 0.27 MPa to about 0.35 MPa, a stress relaxation rate (CFD 70%, about 60 seconds) of about 15% or more, and a restoring rate (about 40% after CFD 70%) of about 70% or more. This elastic sheet may be compressed in a ratio (e.g., amount) of about 30% to about 60% to the initial thickness during the pressing process and exhibit a restoring rate of about 35% to about 80% to the initial thickness during the charge and discharge under the compression condition. An elastic sheet satisfying the above ranges may be configured to transmit or capable of providing substantially uniform pressure to an all-solid-state battery in the pressing state of the battery and in the expansion and contraction process of the battery according to the charges and discharges and thus alleviate stress and suppress or reduce cracks of a solid electrolyte, resulting in improving coulombic efficiency and cycle-life characteristics of the all-solid-state battery

### Acrylate Resin

The acrylate resin may be referred to as a polymer derived from acrylate and/or a derivative thereof or a polymer having a repeating unit derived from acrylate and/or a derivative thereof, and may be referred to as an acrylic resin or an acrylic polymer. The acrylate resin may be synthesized by photopolymerizing or thermally polymerizing acrylate and/or a derivative thereof, which is a type or kind of monomer.

The acrylate resin has a low crosslinking density and a random crosslinking structure compared to the polyurethane material, and thus has excellent or suitable stress relaxation properties by about 10% or more. However, it is difficult to concurrently (e.g., simultaneously) increase the compressive strength and restoring force. However, in an embodiment, the compressive strength is increased without changing the density by applying hollow particles, and the restoring force is increased by applying elastic particles.

For example, the acrylate resin may be derived from an alkyl group-containing acrylate, a hydroxyl group-containing acrylate, or a combination thereof. For example, the acrylate resin may be derived from C1 to C20 alkyl acrylate, hydroxy C1 to C20 alkyl acrylate, or a combination thereof. Herein, C1 to C20 refers to the number of carbon atoms in the alkyl group, and may be, for example, C1 to C18, C1 to C15, C1 to C12, C1 to C10, C1 to C8, or C1 to C5. Herein, the acrylate may include acrylate and methacrylate.

The C1 to C20 alkyl acrylates may be, for example, methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The hydroxy C1 to C20 alkyl acrylate may be, for example, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

For example, the acrylate resin may be derived from C1 to C20 alkyl acrylate and hydroxy C1 to C20 alkyl acrylate, wherein a mixing ratio of the C1 to C20 alkyl acrylate and hydroxy C1 to C20 alkyl acrylate may be a weight ratio of about 20:80 to about 90:10, for example, a weight ratio of about 30:70 to about 90:10, about 40:60 to about 90:10, about 50:50 to about 90:10, or about 60:40 to about 80:20. In this case, the acrylate resin may exhibit appropriate or suitable adhesiveness and is advantageous in realizing excellent or suitable compressive strength, stress relaxation rate, and restoring rate.

The acrylate resin may further include other repeating units derived from acrylic acid, acrylate containing an alkoxy group, and/or the like. In some embodiments, a weight average molecular weight of the acrylate resin may be about 400,000 to about 2,000,000, but is not limited thereto.

### Hollow Particles

The hollow particles are particles that are hollow inside, and may be expressed as hollow spheres or hollow beads, and may be hollow nanoparticles or hollow microparticles. The elastic sheet composition and the elastic sheet prepared therefrom may increase compressive strength while maintaining the density of the acrylate resin by including hollow particles, and may exhibit a form of foam (e.g., may be a foam).

The hollow particles may be included in an amount of about 1 part by weight to about 8 parts by weight, for example, about 1 part by weight to about 7 parts by weight, or about 2 parts by weight to about 6 parts by weight, based on 100 parts by weight of the acrylate resin. When the hollow particles are included in this content (e.g., amount) range, it is advantageous to make a foam-type or kind elastic sheet, and the compressive strength, stress relaxation force, and restoring force of the elastic sheet may be improved.

The hollow particles may be inorganic hollow particles, organic hollow particles, or a combination thereof. For example, the hollow particles may be made of an inorganic material or may be made of an organic material such as a polymer.

The inorganic hollow particles may include, for example, glass, metal oxide, metal carbide, metal fluoride, or a combination thereof. For example, the inorganic hollow particles may be made of glass, silicon oxide, nickel oxide, barium oxide, platinum oxide, zinc oxide, aluminum oxide, zirconium oxide, iron oxide, titanium oxide, calcium carbonate, magnesium fluoride, or a combination thereof, and for example, the inorganic hollow particles may be glass bubbles.

The organic hollow particles may include, for example, an acrylic resin, a vinyl chloride resin, a urea resin, a phenol resin, a rubber, or a combination thereof. In some embodiments, the organic hollow particles may be expandable or non-expandable, and the expandable organic hollow particles may expand, for example, at about 120° C. to about 150° C.

A size (D50) of the hollow particles may be, for example, micro-sized (e.g., in a micro scale), and specifically may be about 2 µm to about 100 µm, about 5 µm to about 90 µm, about 10 µm to about 80 µm, or about 20 µm to about 70 µm. The hollow particles having such a size are advantageous for making a foam-type or kind elastic sheet, and may improve compressive strength of the elastic sheet while lowering its density and improving stress relaxation force and restoring force. Herein, the size of the hollow particles may be expressed as an average particle diameter or a median particle diameter, and may refer to the diameter (D50) of particles having a cumulative volume of about 50 volume% in the particle size distribution as measured by a particle size analyzer.

### Elastic Particles

The elastic particles may be particles made of a polymer having elasticity such as rubber. In the case of a general acrylate resin, it is difficult to concurrently (e.g., simultaneously) increase the stress relaxation force and the restoring force, but the elastic particles may increase the restoring force while maintaining the stress relaxation force of the acrylate resin.

The elastic particles may be included in an amount of about 0.1 parts by weight to about 5 parts by weight, for example, about 0.5 parts by weight to about 4 parts by weight, or about 1 part by weight to about 3 parts by weight, based on 100 parts by weight of the acrylate resin. When the elastic particles are included in the content (e.g., amount) range, compressive strength, stress relaxation force, and restoring force may be maximized or increased without reducing a density and adhesive strength of the acrylate resin.

The elastic particles may include, for example, a polymer derived from natural rubber, alkyl acrylate, olefin, butadiene, isoprene, styrene, acrylonitrile, a copolymer thereof, or a combination thereof. The elastic particles may have, for example, a glass transition temperature of about -70° C. to about 0° C.

The alkyl acrylate may be C1 to C20 alkyl acrylate, for example methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The elastic particles may include, for example, polyalkyl acrylate, an ethylene-propylene-diene rubber, a butadiene rubber, an isoprene rubber, a styrene-butadiene rubber, a styrene-isoprene rubber, an acrylonitrile-butadiene rubber, or a combination thereof.

The elastic particles may have, for example, a core-shell structure, and in this case, it is advantageous to exhibit appropriate or suitable size and elasticity. Each of the core and the shell may include, for example, polyalkyl acrylate, and for example, the core may include polybutyl (meth)acrylate and the shell may include polymethyl (meth)acrylate. In this case, dispersibility in the elastic sheet composition is improved, and the compressive strength, stress relaxation force, and restoring force of the elastic sheet may be improved.

The elastic particles may be, for example, nano-sized (e.g., in a nano scale). For example, the size (D50) of the elastic particles may be about 10 nm to about 900 nm, for example, about 10 nm to about 700 nm, about 50 nm to about 500 nm, or about 100 nm to about 400 nm. The elastic particles satisfying these sizes have excellent or suitable dispersibility in the elastic sheet composition, and may increase a restoring force while maintaining a stress relaxation force of the elastic sheet. Herein, the size of the elastic particles may be expressed as an average particle diameter or a median particle diameter, and may refer to the diameter (D50) of particles having a cumulative volume of about 50 volume% in the particle size distribution as measured by a particle size analyzer.

### Inorganic Particles

The elastic sheet composition for an all-solid-state battery may further include inorganic particles. In this case, while improving a modulus and compressive strength of the elastic sheet, it is possible to concurrently (e.g., simultaneously) improve a restoring rate.

The inorganic particles may include, for example, at least one selected from alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, and magnesium oxide.

The inorganic particles may be, for example, included in an amount of about 0.001 parts by weight to about 50 parts by weight, for example about 0.01 parts by weight to about 45 parts by weight, or about 0.1 parts by weight to about 40 parts by weight based on 100 parts by weight of the acrylate resin. In this case, it is possible to improve the compressive strength, stress relaxation rate and restoring rate of the elastic sheet without deteriorating the properties of the acrylate resin.

An average particle diameter of the inorganic particles may be about 0.1 µm to about 2 µm, for example, about 0.1 µm to about 1.5 µm, or about 0.2 µm to about 1.0 µm. The average particle diameter is measured utilizing a laser scattering particle size distribution analyzer, and may refer to a median particle diameter (D50) when about 50% is accumulated from the small particle side in terms of volume conversion.

### Additives

The elastic sheet composition for an all-solid-state battery may further include appropriate or suitable additives in addition to the aforementioned components, and may further include, for example, an initiator, a crosslinking agent, a coupling agent, and a foam stabilizer. In some embodiments, in order to manufacture a foam-type or kind elastic sheet, the composition may include an inert gas such as nitrogen or argon in addition to or together with a foam stabilizer.

Each of the additives may be included in an appropriate or suitable amount according to the purpose, and may be in an amount of, for example, about 0.001 parts by weight to about 1 part by weight, for example, about 0.01 parts by weight to about 0.8 parts by weight based on 100 parts by weight of the acrylate resin.

### Elastic Sheet for All-Solid-State Battery

In an embodiment, an elastic sheet for an all-solid-state battery made from, made of, or including the aforementioned composition is provided. For example, the elastic sheet for an all-solid-state battery according to an embodiment includes an acrylate resin, hollow particles, and elastic particles. Herein, the types (kinds), characteristics and contents of the acrylate resin, hollow particles, and elastic particles, etc. are as described above. Such an elastic sheet may implement a high stress relaxation rate and a high restoring rate while exhibiting appropriate or suitable compressive strength, thereby improving charge/discharge efficiency and cycle-life characteristics of an all-solid-state battery.

The elastic sheet may be prepared by coating the aforementioned composition on a substrate and then photopolymerizing (or photocuring) or thermally polymerizing (or thermally curing) it.

Such an elastic sheet may be a type or kind of adhesive sheet or may be in the form of a foam. When the elastic sheet is not in the form of a foam, deformation or fracture of the negative electrode and the solid electrolyte may occur due to high compressive strength when compressed.

The foam-type or kind elastic sheet may have a density of about 0.3 g/cm³ to about 0.8 g/cm³, for example, about 0.35 g/cm³ to about 0.75 g/cm³. When the elastic sheet has higher density than the above, the elastic sheet may come out in the plane direction during the pressing, or compressive strength may be excessively high, but when the elastic sheet has lower density than the above, pores and pore walls of the foam are connected according to the charges and discharges, leading to decreasing the restoring force of the elastic sheet.

The elastic sheet may have a single-layer or multi-layer structure, wherein when the elastic sheet has the multi-layer structure, each layer may be formed of the same material or a different material and also, designed to have a different modulus for each sheet.

In some embodiments, the elastic sheet may further include a protective film or a coating layer on one surface thereof.

The elastic sheet may have a thickness of about 100 µm to about 800 µm, for example, about 100 µm to about 600 µm, or about 150 µm to about 500 µm. Within the thickness ranges, the elastic sheet may sufficiently relieve stress due to the pressing and stress according to thickness changes during the charges and discharges and exhibit an excellent or suitable restoring force.

The elastic sheet is characterized to exhibit moderately high compressive strength. The elastic sheet may have compressive strength (CFD 40%) of about 0.27 MPa to about 0.35 MPa, for example, about 0.29 MPa to about 0.35 MPa, or about 0.30 MPa to about 0.35 MPa. Herein, the elastic sheet may be appropriately compressed in a ratio (e.g., amount) of about 30% to about 60% to the initial thickness during the pressing process and sufficiently exhibit buffering ability to relieve stress and to repeat compression and restoration. Herein, the compressive strength may refer to a compressive strength (CFD 40%) measured at about 40% of the initial thickness after the pressing.

The elastic sheet may realize a high stress relaxation rate of about 15% or higher, for example, about 15% to about 20%, or about 16% to about 20%. The stress relaxation rate may be a stress change rate for about 60 seconds after compression to about 40 µm with about 2.5 kgf and specifically, a ratio obtained by dividing stress after about 60 seconds after 70% compression (CFD 70%) by the initial stress during the 70% compression.

In some embodiments, the elastic sheet may realize a high restoring rate of about 70% or higher, for example, about 70% to about 85%, or about 71% to about 80%. Herein, the restoring rate may be a value obtained by dividing stress under 40% compression after the 70% compression (CFD 70%) by the initial stress under the 40% compression.

The elastic sheet may satisfy a modulus of about 0.01 MPa to about 5 MPa at about 45° C., about 1 rad/s.

### Positive Electrode

In an all-solid-state battery, a positive electrode includes a current collector and a positive active material layer on the current collector, and the positive active material layer includes a positive active material and a sulfide-based solid electrolyte, and may optionally include a binder and/or a conductive material. Herein, the current collector may be, for example, an aluminum foil, but is not limited thereto.

### Positive Active Material

The positive active material may include lithiated intercalation compounds that reversibly intercalate and deintercalate lithium ions. Examples of the positive active material include a compound represented by any one of the following chemical formulas:
LiₐA_{1-b}X_{b}D₂ (0.90 ≤ a ≤ 1.8, 0 ≤ b ≤ 0.5);
LiₐA_{1-b}X_{b}O_{2-c}D_{c} (0.90 ≤ a ≤ 1.8, 0 ≤ b ≤ 0.5, 0 ≤ c ≤ 0.05);
LiₐE_{1-b}X_{b}O_{2-c}D_{c} (0.90 ≤ a ≤ 1.8, 0 ≤ b ≤ 0.5, 0 ≤ c ≤ 0.05);
LiₐE_{2-b}X_{b}O_{4-c}D_{c} (0.90 ≤ a ≤ 1.8, 0 ≤ b ≤ 0.5, 0 ≤ c ≤ 0.05);
LiₐNi_{1-b-c}Co_{b}X_{c}D_{α} (0.90 ≤ a ≤1.8, 0 ≤ b ≤ 0.5, 0 ≤ c ≤ 0.5, 0 < α ≤ 2);
LiₐNi_{1-b-c}CO_{b}X_{c}O_{2-α},T_{α}(0.90 ≤ a ≤ 1.8, 0 ≤ b ≤ 0.5, 0 ≤ c ≤ 0.05, 0 < α < 2);
LiₐNi_{1-b-c}CO_{b}X_{c}O_{2-α}T₂(0.90 ≤ a ≤ 1.8, 0 ≤ b ≤ 0.5, 0 ≤ c ≤ 0.05, 0 < α < 2);
LiₐNi_{1-b-c}Mn_{b}X_{c}D_{α} (0.90 ≤ a ≤ 1.8, 0 ≤ b ≤ 0.5, 0 ≤ c ≤ 0.05, 0 < α ≤ 2);
LiₐNi_{1-b-c}Mn_{b}X_{c}O_{2-α}T_{α} (0.90 ≤ a ≤ 1.8, 0 ≤ b ≤ 0.5, 0 ≤ c ≤ 0.05, 0 < α < 2);
LiₐNi_{1-b-c}Mn_{b}X_{c}O_{2-α}T₂ (0.90 ≤ a ≤ 1.8, 0 ≤ b ≤ 0.5, 0 ≤ c ≤ 0.05, 0 < α < 2);
LiₐNi_{b}E_{c}G_{d}O₂ (0.90 ≤ a≤ 1.8, 0 ≤ b ≤ 0.9, 0 ≤ c ≤ 0.5, 0.001 ≤ d ≤ 0.1);
LiₐNi_{b}Co_{c}Mn_{d}GₑO₂ (0.90 ≤ a ≤ 1.8, 0 ≤ b ≤ 0.9, 0 ≤ c ≤ 0.5, 0 ≤ d ≤0.5, 0.001 ≤ e ≤ 0.1);
LiₐNiG_{b}O₂ (0.90 ≤ a ≤ 1.8, 0.001 ≤ b ≤ 0.1);
LiₐCoG_{b}O₂ (0.90 ≤ a ≤ 1.8, 0.001 ≤ b ≤ 0.1);
LiₐMn_{1-b}G_{b}O₂ (0.90 ≤ a ≤ 1.8, 0.001 ≤ b ≤ 0.1);
LiₐMn₂G_{b}O₄ (0.90 ≤ a ≤ 1.8, 0.001 ≤ b ≤ 0.1);
LiₐMn_{1-g}G_{g}PO₄ (0.90 ≤ a ≤ 1.8, 0 ≤ g ≤ 0.5);
QO₂; QS₂; LiQS₂;
V₂O₅; LiV₂O₅;
LiZO₂;
LiNiVO₄;
Li(_{3-f)}J₂(PO₄)₃ (0 ≤ f ≤ 2);
Li(_{3-f)}Fe₂(PO₄)₃ (0 ≤ f ≤ 2);
LiₐFePO₄ (0.90 ≤ a ≤ 1.8).

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive active material may be a lithium-metal composite oxide, for example, lithium cobalt oxide (LCO), lithium nickel oxide (LNO), lithium nickel cobalt oxide (NC), lithium nickel cobalt aluminum oxide (NCA), lithium nickel cobalt, manganese oxide (NCM), lithium manganese oxide (LMO), or lithium iron phosphate (LFP).

In some embodiments, the active material may have a coating layer, e.g., using a coating compound, on the surface thereof, or a mixture of two or more compounds may be utilized in a coating layer. The coating layer may include at least one compoundselected from an oxide of a coating element, a hydroxide of a coating element, an oxyhydroxide of a coating element, an oxycarbonate of a coating element, and a hydroxycarbonate of a coating element. The compound constituting one or more of the coating layers may be amorphous or crystalline. Examples of the coating element or material included in the coating layer may include Mg, Al, Co, K, Na, Ca, Si, Ti, V, Sn, Ge, Ga, B, As, Zr, or a combination thereof. For example, the coating layer may include lithium zirconium oxide, for example Li₂O—ZrO₂. The coating layer forming process may utilize a method that does not adversely affect the physical properties of the positive active material, such as spray coating or dipping.

The positive active material may include, for example, at least one of lithium-metal composite oxides represented by Chemical Formula 11.

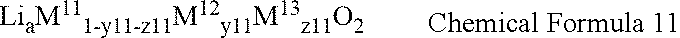

In Chemical Formula 11, 0.9≤a≤1.8, 0≤y11 ≤ 1, 0≤z11≤1, 0≤ y11+z11<1, and M¹¹, M¹², and M¹³ may each independently be any one selected from elements such as Ni, Co, Mn, Al, Mg, Ti, Fe, and one or more combinations thereof.

For example, M¹¹ may be Ni, and M¹² and M¹³ may each independently be a metal such as Co, Mn, Al, Mg, Ti, or Fe. In a specific embodiment, M¹¹ may be Ni, M¹² may be Co, and M¹³ may be Mn or Al, but they are not limited thereto.

In an embodiment, the positive active material may include a lithium nickel-based composite oxide represented by Chemical Formula 12.

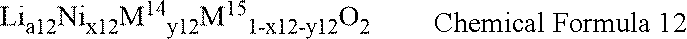

In Chemical Formula 12, 0.9≤a12≤1.8, 0.3≤x12≤1, 0≤y12≤0.7, and M¹⁴ and M¹⁵ may each independently be at least one element selected from Al, B, Ba, Ca, Ce, Co, Cr, F, Fe, Mg, Mn, Mo, Nb, P, S, Si, Sr, Ti, V, W, and Zr.

The positive active material may include, for example, lithium nickel cobalt-based oxide represented by Chemical Formula 13.

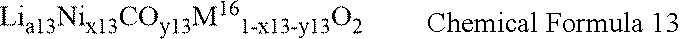

In Chemical Formula 13, 0.9≤a13≤1.8, 0.3≤x13\u003c1, 0\u003cy13≤0.7 and M¹⁶ is at least one element selected from Al, B, Ba, Ca, Ce, Cr, F, Fe, Mg, Mn, Mo, Nb, P, S, Si, Sr, Ti, V, W, and Zr.

In Chemical Formula 13, 0.3≤x13≤0.99 and 0.01≤y13≤0.7; 0.4≤x13≤ 0.99 and 0.01 ≤y13≤0.6; 0.5≤x13≤0.99 and 0.01 ≤y13≤0.5; 0.6≤x13≤0.99 and 0.01≤y13≤0.4; 0.7≤x13≤0.99 and 0.01≤y13≤0.3; 0.8≤x13≤0.99 and 0.01≤y13 ≤0.2; or 0.9≤x13≤0.99 and 0.01≤y13≤0.1.

A nickel content (e.g., amount) in the lithium nickel-based composite oxide may be greater than or equal to about 30 mol%, for example greater than or equal to about 40 mol%, greater than or equal to about 50 mol%, greater than or equal to about 60 mol%, greater than or equal to about 70 mol%, greater than or equal to about 80 mol%, or greater than or equal to about 90 mol% and less than or equal to about 99.9 mol%, or less than or equal to about 99 mol% based on the total amount of metals excluding lithium. For example, the nickel content (e.g., amount) in the lithium nickel-based composite oxide may be higher than the content (e.g., amount) of each of other metals such as cobalt, manganese, and aluminum. When the nickel content (e.g., amount) satisfies the above range, the positive active material may exhibit excellent or suitable battery performance while realizing a high capacity.

An average particle diameter of the positive active material may be about 1 µm to about 25 µm, for example, about 4 µm to about 25 µm, about 5 µm to about 20 µm, about 8 µm to about 20 µm, or about 10 µm to about 18 µm. A positive active material having such a particle size range can be harmoniously mixed with other components in a positive active material layer and can realize high capacity and high energy density.

The positive active material may be in a form of secondary particles formed by aggregating a plurality of primary particles, or may be in a form of single particles (e.g., a particle have a single continuous body or crystal phase). In some embodiments, the positive active material may have a spherical or near-spherical shape, or may have a polyhedral or irregular shape.

Based on the total weight of the positive active material layer, the positive active material may be included in an amount of about 55 wt% to about 99.7 wt%, for example about 74 wt% to about 89.8 wt%. When included in the above range, cycle-life characteristics may be improved while maximizing or increasing the capacity of the all-solid-state battery.

### Solid Electrolyte

The solid electrolyte may be an inorganic solid electrolyte such as a sulfide-based solid electrolyte or an oxide-based solid electrolyte or a solid polymer electrolyte.

In an embodiment, the solid electrolyte may be a sulfide-based solid electrolyte having excellent or suitable ionic conductivity. The sulfide-based solid electrolyte may be, for example, Li₂S—P₂S₅, Li₂S—P₂S₅—LiX (X is a halogen element, for example I, or Cl), Li₂S—P₂S₅—Li₂O, Li₂S—P₂S₅—Li₂O—Lil, Li₂S—SiS₂, Li₂S—SiS₂—Lil, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer and Z is Ge, Zn, or Ga), Li₂S—GeS₂, Li₂S—SiS₂—Li₃PO₄, Li₂S—SiS₂—LiₚMO_{q} (p and q are integers and M is P, Si, Ge, B, Al, Ga, or In), and/or the like.

The sulfide-based solid electrolyte may be obtained by, for example, mixing Li₂S and P₂S₅ in a mole ratio of about 50:50 to about 90:10 or about 50:50 to about 80:20. Within the above mixing ratio range, a sulfide-based solid electrolyte having excellent or suitable ionic conductivity may be prepared. The ionic conductivity may be further improved by adding SiS₂, GeS₂, B₂S₃, and/or the like as other components thereto. The mixing may be performed by a mechanical milling or solution method. The mechanical milling is to make starting materials into particulates by putting the starting materials, ball mills, and/or the like in a reactor and fervently or suitably stirring them. The solution method may be performed by mixing the starting materials in a solvent to obtain a solid electrolyte as a precipitate. In some embodiments, after the mixing, firing or heating may be additionally performed. When the additional firing is performed, the solid electrolyte may have substantially or relatively rigid crystals.

For example, the solid electrolyte may be an argyrodite-type or kind sulfide-based solid electrolyte. The sulfide-based solid electrolyte may be, for example, LiₐM_{b}P_{c}S_{d}Aₑ (a, b, c, d, and e are all greater than or equal to about 0 and less than or equal to about 12, M is Ge, Sn, Si, or a combination thereof, and A is one of F, Cl, Br, or l) and specifically, Li₃PS₄, Li₇P₃S₁₁, Li₆PS₅Cl, and/or the like. This sulfide-based solid electrolyte has high ionic conductivity close to about 10⁻⁴ to about 10⁻² S/cm, which is ionic conductivity of a general liquid electrolyte, at room temperature and thus, a close bond may be formed between the positive active material and the solid electrolyte, and further, a close interface may be formed between the electrode layer and the solid electrolyte layer without deteriorating the ionic conductivity. An all-solid-state rechargeable battery including the same may exhibit improved battery performance such as rate capability, coulombic efficiency, and cycle-life characteristics.

The sulfide-based solid electrolyte may be amorphous or crystalline, and may be in a mixed state.

The solid electrolyte may be an oxide-based inorganic solid electrolyte in addition to the sulfide-based material. The oxide-based inorganic solid electrolyte may include, for example, Liᵢ₊ₓTi₂₋ₓAl(PO₄)₃(LTAP)(0≤x≤4), Li_{1+x+y}AlₓTi₂₋ₓSi_{y}P₃₋_{y}O₁₂(0<x<2, 0≤y<3), BaTiO₃, Pb(Zr,Ti)O₃(PZT), Rb₁₋ₓLaₓZr_{1-y}Ti_{y}O₃(PLZT)(0≤x<1, 0≤y<1 ), PB(Mg₃Nb_{⅔})O₃-PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P₃₋_{y}O₁₂ (0≤_{X}≤1, 0≤y≤1 ), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂—based ceramics, garnet-based ceramics Li₃+ₓLa₃M₂O₁₂ (M = Te, Nb, or Zr; x is an integer from 1 to 10), or mixtures thereof.

The solid electrolyte may be in a form of particles, and the average particle diameter (D50) thereof may be less than or equal to about 5.0 µm, for example, about 0.1 µm to about 5.0 µm, about 0.5 µm to about 5.0 µm, about 0.5 µm to about 4.0 µm, about 0.5 µm to about 3.0 µm, about 0.5 µm to about 2.0 µm, or about 0.5 µm to about 1.0 µm. Such a solid electrolyte may effectively penetrate between the positive active materials, and has an excellent or suitable contact property with the positive active materials and connectivity between the solid electrolyte particles.

Based on the total weight of the positive active material layer, the solid electrolyte may be included in an amount of about 0.1 wt% to about 35 wt%, for example, about 1 wt% to about 35 wt%, about 5 wt% to about 30 wt%, about 8 wt% to about 25 wt%, or about 10 wt% to about 20 wt%. In some embodiments, about 65 wt% to about 99 wt% of the positive active material and about 1 wt% to about 35 wt% of the solid electrolyte, for example about 80 wt% to about 90 wt% of the positive active material and about 10 wt% to about 20 wt% of the solid electrolyte may be included in the positive active material layer, based on the total weight of the positive active material and the solid electrolyte. When the solid electrolyte is included in the positive electrode in such a content (e.g., amount), the efficiency and cycle-life characteristics of the all-solid-state battery may be improved without reducing the capacity.

### Binder

The binder improves binding properties of positive active material particles with one another and with a current collector. Examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, a vinylidenefluoride-hexafluoropropylene copolymer, polyethylene, polypropylene, a styrene butadiene rubber, an acrylated styrene butadiene rubber, polyacrylonitrile, an epoxy resin, nylon, poly(meth)acrylate, polymethyl(meth)acrylate, and/or the like, but are not limited thereto.

Among them, the binder according to an embodiment may be one or more selected from polyvinylidene fluoride, vinylidene fluoride-hexafluoropropylene copolymer, polytetrafluoroethylene, a styrene butadiene rubber, polyacrylonitrile, and polymethyl (meth)acrylate. These binders may be well, substantially, or suitably dissolved in the dispersion media in the positive electrode composition, and thus, substantially uniform coating may be possible and excellent or suitable electrode plate performance may be realized.

The binder may be included in an amount of about 0.1 wt% to about 5 wt%, or about 0.1 wt% to about 3 wt%, based on the total weight of each component of the all-solid-state battery positive electrode or based on the total weight of the positive active material layer. In the above content (e.g., amount) range, the binder may sufficiently exhibit adhesive ability without degrading battery performance.

### Conductive Material

The conductive material is included to provide electrode conductivity and any suitable electrically conductive material may be utilized as a conductive material unless it causes a chemical change. The conductive material may include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum, silver, and/or the like; a conductive polymer such as a polyphenylene derivative; or a mixture thereof.

The conductive material may be included in an amount of about 0.1 wt% to about 5 wt%, or about 0.1 wt% to about 3 wt%, based on the total weight of each component of the positive electrode for an all-solid-state battery or based on the total weight of the positive active material layer. In the above content (e.g., amount) range, the conductive material may improve electrical conductivity without degrading battery performance.

The positive active material layer may include about 55 wt% to about 99.7 wt% of the positive active material; about 0.1 wt% to about 35 wt% of the solid electrolyte; about 0.1 wt% to about 5 wt% of the binder; and about 0.1 wt% to about 5 wt% of the conductive material based on the total weight of the positive active material. As a specific example, about 74 wt% to about 89.8 wt% of the positive active material; about 10 wt% to about 20 wt% of the solid electrolyte; about 0.1 wt% to about 3 wt% of the binder; and about 0.1 wt% to about 3 wt% of the conductive material may be included. When mixed in the above content (e.g., amount) range, cycle-life characteristics of a battery may be improved while maximizing or increasing capacity.

### Negative Electrode

The negative electrode for an all-solid-state battery may include, for example, a current collector and a negative active material layer on the current collector. The negative active material layer may include a negative active material, and may further include a binder, a conductive material, and/or a solid electrolyte.

The negative active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy includes an alloy of lithium and at least one metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative active material or a Sn-based negative active material. The Si-based negative active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si), and the Sn-based negative active material may include Sn, SnO₂, a Sn-R alloy (wherein R is an alkali metal, an alkaline-earth metal, a Group 13 element, a Group 14 element, a Group 15 element, a Group 16 element, a transition metal, a rare earth element, or a combination thereof, but not Sn). At least one of these materials may be mixed with SiO₂. The elements Q and R may be (e.g., each be) selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content (e.g., amount) of silicon may be about 10 wt% to about 50 wt% based on the total weight of the silicon-carbon composite. In some embodiments, the content (e.g., amount) of the crystalline carbon may be about 10 wt% to about 70 wt% based on the total weight of the silicon-carbon composite, and the content (e.g., amount) of the amorphous carbon may be about 20 wt% to about 40 wt% based on the total weight of the silicon-carbon composite. In some embodiments, a thickness of the amorphous carbon coating layer may be about 5 nm to about 100 nm.

The average particle diameter (D50) of the silicon particles may be about 10 nm to about 20 µm, and for example about 10 nm to about 200 nm. The silicon particles may exist in an oxidized form, and in this case, an atomic content (e.g., amount) ratio of Si:O in the silicon particles indicating a degree of oxidation may be a weight ratio of about 99:1 to about 33:67. The silicon particles may be SiOₓ particles, and in this case, the range of x in SiOₓ may be greater than about 0 and less than about 2.

The Si-based negative active material or Sn-based negative active material may be mixed with the carbon-based negative active material. A mixing ratio of the Si-based negative active material or Sn-based negative active material; and the carbon-based negative active material may be about 1:99 to about 90:10 in weight ratio.

In the negative active material layer, the negative active material may be included in an amount of about 95 wt% to about 99 wt% based on the total weight of the negative active material layer.

In an embodiment, the negative active material layer further includes a binder, and may optionally further include a conductive material. The content (e.g., amount) of the binder in the negative active material layer may be about 1 wt% to about 5 wt% based on the total weight of the negative active material layer. In some embodiments, when the conductive material is further included, the negative active material layer may include about 90 wt% to about 98 wt% of the negative active material, about 1 wt% to about 5 wt% of the binder, and about 1 wt% to about 5 wt% of the conductive material.

The binder serves to well adhere the negative active material particles to each other and also to adhere the negative active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. As the alkali metal, Na, K, or Li may be utilized. The amount of the thickener utilized may be about 0.1 parts by weight to about 3 parts by weight based on 100 parts by weight of the negative active material.

The conductive material is included to provide electrode conductivity. Any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum silver, and/or the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

On the other hand, the negative electrode for an all-solid-state battery may be, for example, a precipitation-type or kind negative electrode. The precipitation-type or kind negative electrode is a negative electrode which has no negative active material during the assembly of a battery but in which a lithium metal and/or the like are precipitated during the charge of the battery and serve as a negative active material.

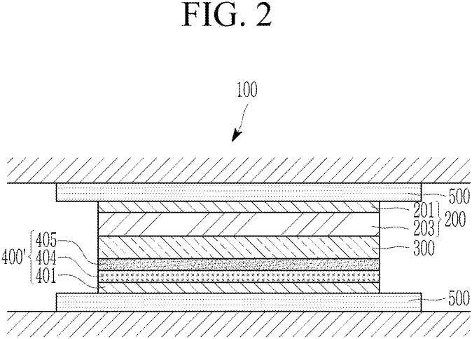

FIG. 2 is a schematic cross-sectional view of an all-solid-state battery including a precipitation-type or kind negative electrode. Referring to FIG. 2, the precipitation-type or kind negative electrode 400′ may include the current collector 401 and a negative electrode catalyst layer 405 disposed on the current collector. The all-solid-state battery having this precipitation-type or kind negative electrode 400′ starts to be initially charged in absence of a negative active material, and a lithium metal with high density and/or the like are precipitated between the current collector 401 and the negative electrode catalyst layer 405 during the charge and form a lithium metal layer 404, which may work as a negative active material. Accordingly, the precipitation-type or kind negative electrode 400′, in the all-solid-state battery which is more than once charged, may include the current collector 401, the lithium metal layer 404 on the current collector, and the negative electrode catalyst layer 405 on the metal layer 404. The lithium metal layer 404 refers to a layer of the lithium metal and/or the like precipitated during the charge of the battery and may be called to be a metal layer, a negative active material layer, and/or the like.

The negative electrode catalyst layer 405 may include a metal and/or a carbon material which plays a role of a catalyst.

The metal may include, for example, gold, platinum, palladium, silicon silver, aluminum, bismuth, tin, zinc, or a combination thereof and may be composed of one selected therefrom or an alloy of more than one. The metal average particle diameter (D50) may have an average particle diameter (D50) of less than or equal to about 4 µm, for example about 10 nm to about 4 µm, about 10 nm to about 2 µm, or about 10 nm to about 1 µm.

The carbon material may be, for example, crystalline carbon, non-graphitic carbon, or a combination thereof. The crystalline carbon may be, for example, at least one selected from natural graphite, artificial graphite, mesophase carbon microbead, and a combination thereof. The non-graphite-based carbon may be at least one selected from carbon black, activated carbon, acetylene black, denka black, ketjen black, furnace black, graphene, and a combination thereof.

When the negative electrode catalyst layer 405 includes the metal and the carbon material, the metal and the carbon material may be, for example, mixed in a weight ratio of, for example, about 1:10 to about 1:2, about 1:10 to about 2:1, about 5:1 to about 1:1, or about 4:1 to about 2:1. Herein, the precipitation of the lithium metal may be effectively promoted and improve characteristics of the all-solid-state battery. The negative electrode catalyst layer 405 may include, for example, a carbon material on which a catalyst metal is supported or a mixture of metal particles and carbon material particles.

The negative electrode catalyst layer 405 may further include a binder, and the binder may be a conductive binder. In some embodiments, the negative electrode catalyst layer 405 may further include general additives such as a filler, a dispersing agent, an ion conductive material, and/or the like.

The negative electrode catalyst layer 405 may have, for example, a thickness of about 1 µm to about 20 µm, about 2 µm to about 10 µm, or about 3 µm to about 7 µm. Also, the thickness of the negative electrode catalyst layer 405 may be less than or equal to about 50%, less than or equal to about 20%, or less than or equal to about 5% of the thickness of the positive active material layer. When the thickness of the negative electrode catalyst layer 405 is too thin, it may be collapsed by the lithium metal layer 404, and when the thickness is too thick, the density of the all-solid-state battery may decrease and internal resistance may increase.

The precipitation-type or kind negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and/or the like, which may be utilized alone or an alloy of more than one. The thin film may further planarize a precipitation shape of the lithium metal layer 404 and much improve characteristics of the all-solid-state battery. The thin film may be formed, for example, in a vacuum deposition method, a sputtering method, a plating method, and/or the like. The thin film may have, for example, a thickness of about 1 nm to about 800 nm, or about 100 nm to about 500 nm.

The lithium metal layer 404 may include a lithium metal or a lithium alloy. The lithium alloy may be for example a Li—Al alloy, a Li—Sn alloy, a Li—ln alloy, a Li—Ag alloy, a Li—Au alloy, a Li—Zn alloy, a Li—Ge alloy, or a Li—Si alloy.

The lithium metal layer 404 may have a thickness of about 1 µm to about 500 µm, about 1 µm to about 200 µm, about 1 µm to about 100 µm, or about 1 µm to about 50 µm. When the thickness of the lithium metal layer 404 is too thin, it is difficult to perform a role of a lithium storage, and when it is too thick, the performance may deteriorate as the battery volume increases.

When such a precipitation-type or kind negative electrode is applied, the negative electrode catalyst layer 405 may play a role of protecting the lithium metal layer 404 and inhibiting a growth of lithium dendrite. Accordingly, short-circuit and capacity degradation of all-solid-state batteries may be suppressed or reduced and cycle-life characteristics may be improved.

### Solid Electrolyte Layer

The solid electrolyte layer 300 includes a solid electrolyte, and the solid electrolyte may be an inorganic solid electrolyte such as a sulfide-based solid electrolyte or an oxide-based solid electrolyte, or a solid polymer electrolyte. Because the description of the type or kind of solid electrolyte is the same as above, it is not provided.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof, but is not limited thereto. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer can be any suitable in the art, and a detailed description thereof will not be provided.

A thickness of the solid electrolyte layer may be, for example, about 10 µm to about 150 µm.

The solid electrolyte layer may further include an alkali metal salt and/or an ionic liquid and/or a conductive polymer.

The alkali metal salt may be, for example, a lithium salt. A content (e.g., amount) of the lithium salt in the solid electrolyte layer may be greater than or equal to about 1 M, for example, about 1 M to about 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, Lil, LiB(C₂O₄)₂, LiBF₄, LiBF₃(C₂F₅), lithium bis(34xalate) borate (LiBOB), lithium oxalyldifluoroborate (LIODFB), lithium difluoro(34xalate) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In some embodiments, the lithium salt may be an imide-based salt, for example, the imide-based lithium salt may be lithium bis(trifluoromethanesulfonyl) imide (LiTFSI, LiN(SO₂CF₃)₂), and/or lithium bis(fluorosulfonyl)imide (LiFSI, LiN(SO₂F)₂). The lithium salt may maintain or improve ionic conductivity by appropriately maintaining chemical reactivity with the ionic liquid.

Because the ionic liquid has a melting point below room temperature, it is a liquid state at room temperature and refers to a salt or room temperature fusion salt composed only of ions.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations, and a mixture thereof, and b) at least one anion selected from BF₄—, PF₆—, AsF₆—, SbF₆—, AlCl₄—, HSO₄-, ClO₄—, CH₃SO₃—, CF₃CO₂—, Cl—, Br—, I—, BF₄—, SO₄—, CF₃SO₃—, (FSO₂)₂N-, (C₂F₅SO₂)₂N—, (C₂F₅SO₂)(CF₃SO₂)N—, and (CF₃SO₂)₂N—.

The ionic liquid may be for example, selected from N-methyl-N-propylpyrroldinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)am ide.

A weight ratio of the solid electrolyte and the ionic liquid in the solid electrolyte layer may be about 0.1 :99.9 to about 90:10, for example, about 10:90 to about 90:10, about 20:80 to about 90:10, about 30:70 to about 90: 10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

An all-solid-state battery according to an embodiment may be manufactured by sequentially stacking a positive electrode, a solid electrolyte, and a negative electrode to prepare a stack, adhering an elastic sheet to the outer surface of the positive electrode and/or negative electrode, and then pressing it. The pressing may be performed at a temperature of, for example, about 25° C. to about 90° C., and may be performed at a pressure of less than or equal to about 550 Mpa, or less than or equal to about 500 Mpa, for example, about 400 Mpa to about 500 Mpa. The pressing may be for example isostatic press, roll press, or plate press.

Under these pressing conditions, the aforementioned elastic sheet may be compressed at an appropriate or suitable ratio of about 30% to about 60% compared to the initial thickness, and may be compressed, and a restoring rate of the elastic sheet may satisfy a ratio of about 35% to about 80% compared to the initial thickness.

The all-solid-state secondary battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, for example, a coin type or kind, a button type or kind, a sheet type or kind, a stack type or kind, a cylindrical shape, a flat type or kind, and/or the like. In some embodiments, the all-solid-state battery may be applied to or be medium and/or large-sized batteries utilized in electric vehicles and/or the like. For example, the all-solid-state battery may also be utilized in a hybrid vehicle such as a plug-in hybrid electric vehicle (PHEV). In some embodiments, it may be applied to an energy storage system (ESS) requiring a large amount of power or energy storage, and may also be applied to an electric bicycle or power tool.

Hereinafter, examples of the present disclosure and comparative examples are described. It is to be understood, however, that the examples are for the purpose of illustration and are not to be construed as limiting the present disclosure.

### Example 1

### 1. Preparation of Elastic Sheet

In order to prepare an elastic sheet, a solvent-free acrylate mixed resin having a weight average molecular weight of 1,200,000 was first prepared. 4-hydroxybutyl acrylate (4-HBA, Osaka Organic Chemical Industry Co., Ltd.) was mixed with 2-ethylhexyl acrylate (2-EHA, LG Chem) in a weight ratio of 30:70, 0.01 parts by weight of a photoinitiator (lrgacure651) was added thereto, and ultraviolet rays were irradiated thereto for several minutes by utilizing a lamp (e.g., ultraviolet (UV) light) with UV intensity of 10 mw/cm² after exchanging the dissolved oxygen with nitrogen gas in a reactor to partially polymerize the monomers, preparing the acrylate resin as a viscous liquid with viscosity of 4,000 cps at 25° C.

Glass bubbles (3M™ K1, a median particle diameter: 65 µm) as hollow particles were prepared. As for elastic particles, organic nano particles, which were prepared in an emulsion polymerization method and core-shell particles composed or made of a polybutylacrylate core of 70 wt% and a polymethylmethacrylate shell of 30 wt% and had an average particle diameter of 200 nm and a refractive index of 1.48, were prepared.

100 parts by weight of the prepared acrylate resin, 2 parts by weight of the elastic particles, and 0.01 parts by weight of the initiator (lrgacure651) were mixed in the reactor. To the aforementioned viscosity liquid, 0.3 parts by weight of the initiator (lrgacure651), 0.1 parts by weight of hexanedioldiacrylate as a crosslinking agent, 0.1 parts by weight of 3-glycidoxypropyltrimethoxysilane (KBM-403) as a silane coupling agent, 4 parts by weight of the hollow particles, 0.01 parts by weight of mesoporous silica, and 0.1 parts by weight of fumed silica (AEROSIL 200) were added, preparing an elastic sheet composition having adhesiveness.

The elastic sheet composition was applied between polyethyleneterephthalate (PET) films, which were release films, and ultraviolet rays were irradiated thereinto with a light dose of 2000 mJ/cm², forming an elastic sheet adhered on the PET film.

### 2. Manufacture of All-Solid-State Battery Cell

### Manufacture of Positive Electrode

85 wt% of LiNi_{0.8}Co_{0.15}Mn_{0.05}O₂ of a positive active material coated with Li₂O—ZrO₂, 13.5 wt% of Li₆PS₅Cl of a lithium argyrodite-type or kind solid electrolyte, 1.0 wt% of a polyvinylidene fluoride binder, and 0.5 wt% of a carbon nanotube conductive material were mixed to prepare a positive electrode composition. The positive electrode composition was bar-coated on an aluminum positive electrode current collector and then, dried and rolled to manufacture a positive electrode.

### Manufacture of Solid Electrolyte Layer

An acryl-based binder (SX-A334, Zeon Chemicals L.P.) was dissolved in isobutyryl isobutyrate (IBIB) as a solvent to prepare a binder solution, and Li₆PS₅Cl (D50=3 µm) of an argyrodite-type or kind solid electrolyte was added thereto and then, stirred in a thinky mixer to secure appropriate or suitable viscosity. After adjusting viscosity, 2 mm zirconia balls were added thereto and then, stirred with the thinky mixer again, preparing slurry. The slurry included 98.5 wt% of the solid electrolyte and 1.5 wt% of the binder. The slurry was bar-coated on a release PET film and dried at room temperature to form a solid electrolyte layer.

### Manufacture of Negative Electrode

A negative electrode catalyst layer composition was prepared by mixing carbon black with a primary particle diameter (D50) of about 30 nm and silver (Ag) with an average particle diameter (D50) of about 60 nm in a weight ratio of 3:1 to obtain a catalyst and adding 0.25 g of the catalyst to 2 g of an NMP solution including 7 wt% of a polyvinylidene fluoride binder. This negative electrode catalyst layer composition was bar-coated on a nickel thin film of a current collector and vacuum-dried, preparing a precipitation-type or kind negative electrode having a negative electrode catalyst layer on the current collector.

### Manufacture of All-Solid-State Battery Cell

The positive electrode, the solid electrolyte layer, and the negative electrode were cut and then, stacked in the order, and then, the prepared elastic sheet was stacked on the negative electrode. Subsequently, the negative electrode, the solid electrolyte layer, and the positive electrode were sequentially stacked again thereon to prepare an assembly of positive electrode/solid electrolyte/negative electrode/elastic sheet/negative electrode/solidelectrolyte/positive electrode in order. This obtained assembly was put into a laminate film and subjected to a warm isostatic press (WIP) with 500 Mpa at 80° C. for 30 minutes, manufacturing an all-solid-state battery cell.

In the pressurized state, the positive active material layer had a thickness of about 100 µm, the negative electrode catalyst layer had a thickness of about 7 µm, the solid electrolyte layer had a thickness of about 60 µm, and the elastic sheet had a thickness of about 120 µm.

### Example 2

An elastic sheet and an all-solid-state battery cell were manufactured in substantially the same manner as in Example 1 except that the elastic sheet was prepared by changing the hollow particles into expandable organic microscopic hollow particles (D50 = 20 µm) and performing the heat treatment at 140° C. for 4 minutes after curing with ultraviolet rays.

### Example 3

An elastic sheet and an all-solid-state battery cell were manufactured in substantially the same manner as in Example 1 except that the elastic sheet was prepared by changing the content (e.g., amount) of the hollow particles into 1 part by weight and adding a foam stabilizer to disperse the bubbles.

### Comparative Example 1

An elastic sheet and an all-solid-state battery cell were manufactured in substantially the same manner as in Example 1 except that the elastic sheet was prepared by adding no hollow particles.

### Comparative Example 2

An elastic sheet and an all-solid-state battery cell were manufactured in substantially the same manner as in Example 2 except that the elastic sheet was prepared by changing the content (e.g., amount) of the hollow particles into 10 parts by weight.

### Comparative Example 3

An elastic sheet and an all-solid-state battery cell were manufactured in substantially the same manner as in Example 3 except that the elastic sheet was prepared by adding no hollow particles.

### Comparative Example 4

An elastic sheet and an all-solid-state battery cell were manufactured in substantially the same manner as in Example 1 except that the elastic sheet was prepared by adding no mesoporous silica.

### Comparative Example 5

An elastic sheet and an all-solid-state battery cell were manufactured in substantially the same manner as in Example 1 except that the elastic sheet was prepared by adding no elastic particles.

### Evaluation Example 1: Evaluation of Compressive Strength

The elastic sheets according to the examples and the comparative examples were evaluated with respect to compressive strength, and the results are shown in Table 1. Herein, the compressive strength was a value at CFD (compression force deflection) 40%, which refers to that an elastic layer was physically compressed by 40%. The compressive strength was calculated according to Calculation Equation 1 by measuring a load, when a specimen was compressed by 40% at a compression rate of 0.6 mm/min (10 µm/sec) and restored to an original thickness of 60%, by utilizing a compression tester with a spherical jig with a diameter of 10 mm.

$$\begin{matrix}\text{Compressive strength} \left(\text{Mpa}\right) = \left[\text{load at 40\% compression} \left(\text{kgf}\right)\right] / \\ \left[\text{area} \left({\text{cm}}^{2}\right) \text{of specimen}\right] \times 0.1\end{matrix} \qquad \text{Calculation Equation 1}$$

### Evaluation Example 2: Evaluation of Stress Relaxation Rate

The elastic sheets according to the examples and the comparative examples were evaluated with respect to a stress relaxation rate, and the results are shown in Table 1. The stress relaxation rate represents a stress variation rate for 60 seconds after primarily pressing the elastic sheets under a pressure condition of 2.5 kgf and immediately, secondarily pressing them to 40 µm. For example, the stress relaxation rate may be obtained by dividing a stress value at 60 seconds after the secondary compression by an initial stress value right after the secondary compression.

$$\begin{matrix}\text{Stress relaxation rate} \left(\%\right) = \left(\text{stress at 60 seconds after 40} μ \text{} \text{m}\right) \\ \left(\text{compression}\right) / \left(\text{initial stress during 40} μ \text{} \text{m compression}\right) \times 100\end{matrix} \qquad \text{Calculation Equation 2}$$

### Evaluation Example 3: Evaluation of Restoration Rate

The elastic sheets according to the examples and the comparative examples were evaluated with respect to a restoration rate, and the results are shown in Table 1. The restoration rate represents a ratio of stress at the time of returning to the start of the second compression after primarily compressing the sheets under a compression condition of 2.5 kgf, immediately, secondarily compressing them to 40 µm, and then, maintaining them for 60 seconds. For example, the restoration rate was obtained by the stress at the time of returning to the start of the second compression after 60 seconds after the secondary compression by the stress at the start of the secondary compression after the primary compression.

$$\begin{matrix}\text{Restoring rate} \left(\%\right) = \left(\text{stress upon restoration to initial point after}\right) \\ \left(\text{40} μ \text{} \text{m compression}\right) / \left(\text{initial stress upon 40} μ \text{} \text{m compression}\right) \times 100\end{matrix} \qquad \text{Calculation Equation 3}$$

### Evaluation Example 4: Evaluation of Battery Cycle-Life Characteristics

The all-solid-state battery cells according to the examples and the comparative examples were put in a test module and fixed with a force of 5000 gf and then, charged with a constant current of 0.1 C to an upper limit voltage of 4.25 V and discharged to a cut-off voltage of 2.5 V at 0.1 C at 45° C., which was performed as initial charge and discharge.

After the initial charge and discharge, the all-solid-state battery cells were 300 times repeatedly charged at 0.33 C and discharged at 0.33 C within a voltage range of 2.5 V to 4.25 V at 45° C. (e.g., charged and recharged for 300 times), and the number of cycles when the discharge capacity retention to the initial discharge capacity deteriorated to less than 90% (for each example) is provided in Table 1.

TABLE 1

| | Compressive strength (CFD 40%, Mpa) | Stress relaxation rate (%) | Restori ng rate (%) | Cycle-life (cycle number) |
|---|---|---|---|---|
| Example 1 | 0.32 | 16 | 72 | >300 |
| Example 2 | 0.30 | 15 | 71 | >300 |
| Example 3 | 0.33 | 17 | 75 | >300 |
| Comparative Example 1 | 0.25 | 18 | 69 | 180 |
| Comparative Example 2 | 0.36 | 13 | 60 | 100 |
| Comparative Example 3 | 0.28 | 15 | 64 | 210 |
| Comparative Example 4 | 0.31 | 15 | 68 | 300 |
| Comparative Example 5 | 0.31 | 16 | 68 | - |

Referring to Table 1, in Comparative Example 1, in which hollow particles were not applied to the elastic sheet, the elastic sheet exhibited low compressive strength of 0.25 Mpa, and the all-solid-state battery cell exhibited inferior cycle-life characteristics, compared with Example 1. In Comparative Example 2, in which 10 parts by weight of hollow particles were utilized, the elastic sheet exhibited high compressive strength but deteriorated stress relaxation rate and restoring rate, and the all-solid-state battery cell exhibited inferior cycle-life characteristics, compared with Example 2. In some embodiments, Comparative Example 3, in which hollow particles were not utilized, the elastic sheet exhibited all deteriorated compressive strength, stress relaxation rate, and restoring rate, and the all-solid-state battery cell exhibited deteriorated cycle-life characteristics, compared with Example 3.

In Comparative Example 4, in which mesoporous silica, a type or kind of inorganic particles, was not utilized, the elastic sheet exhibited deteriorated compressive strength, deteriorated stress relaxation rate, and deteriorated restoring rate, and the all-solid-state battery cell also exhibited deteriorated cycle-life characteristics, compared with Example 1.

In some embodiments, Comparative Example 5, in which elastic particles were not utilized, exhibited a low restoring rate of 68%.

In contrast, in Examples 1 to 3, the elastic sheets all exhibited high compressive strength of greater than or equal to 0.30 Mpa, a high stress relaxation rate of greater than or equal to 15%, and a high restoring rate of greater than or equal to 71%, and the all-solid-state battery cells exhibited improved cycle-life characteristics of at least 300 cycles (e.g., > 300 cycles).

While this disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims, and equivalents thereof.

Description of Symbols

| | |
|---|---|
| 100: all-solid-state battery | 200: positive electrode |
| 201: positive electrode current collector | |
| 203: positive active material layer | |
| 300: solid electrolyte layer | 400: negative electrode |
| 401: negative current collector | 403: negative active material layer |

400′: precipitation-type or kind negative electrode
404: lithium metal layer
405: negative electrode catalyst layer
500: elastic layer

What is claimed is:

1. An elastic sheet composition for an all-solid-state battery, the elastic sheet composition comprising: an acrylate resin; a plurality of hollow particles, and a plurality of elastic particles.

2. The elastic sheet composition of claim 1, wherein
the elastic sheet composition comprises,
based on 100 parts by weight of the acrylate resin,
about 1 part by weight to about 8 parts by weight of the hollow particles, and
about 0.1 parts by weight to about 5 parts by weight of the elastic particles.

3. The elastic sheet composition of claim 1, wherein
the acrylate resin is derived from C1 to C20 alkyl acrylate, hydroxy C1 to C20 alkyl acrylate, or a combination thereof.

4. The elastic sheet composition of claim 1, wherein
the hollow particles are inorganic hollow particles, organic hollow particles, or a combination thereof,
the inorganic hollow particles comprise glass, metal oxide, metal carbide, metal fluoride, or a combination thereof, and
the organic hollow particles comprise an acrylic resin, a vinyl chloride resin, a urea resin, a phenol resin, or a combination thereof.

5. The elastic sheet composition of claim 1, wherein
the hollow particles have a size (D50) of about 2 µm to about 100 µm.

6. The elastic sheet composition of claim 1, wherein
the elastic particles have a core-shell structure and are derived from alkyl acrylate, olefin, butadiene, isoprene, styrene, acrylonitrile, a copolymer thereof, or a combination thereof.

7. The elastic sheet composition of claim 1, wherein
the elastic particles have a size (D50) of about 10 nm to about 900 nm.

8. The elastic sheet composition of claim 1, wherein
the elastic sheet composition further comprises inorganic particles, and
the inorganic particles are at least one selected from alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, and magnesium oxide.

9. The elastic sheet composition of claim 8, wherein
the inorganic particles are included in an amount of about 0.001 parts by weight to about 50 parts by weight based on 100 parts by weight of the acrylate resin.

10. The elastic sheet composition of claim 1, wherein
the elastic sheet composition comprises at least one additive selected from an initiator, a crosslinking agent, a coupling agent, and a foam stabilizer.

11. The elastic sheet composition of claim 10, wherein
the additive is in an amount of about 0.001 parts by weight to about 1 part by weight based on 100 parts by weight of the acrylate resin.

12. An elastic sheet for an all-solid-state battery, the elastic sheet being prepared from the elastic sheet composition according to claim 1.

13. The elastic sheet of claim 12, wherein
the elastic sheet is a foam-type adhesive sheet.

14. The elastic sheet of claim 12, wherein
the elastic sheet has a thickness of about 100 µm to about 800 µm.

15. The elastic sheet of claim 12, wherein
the elastic sheet has a density of about 0.3 g/cm³ to about 0.8 g/cm³.

16. The elastic sheet of claim 12, wherein
the elastic sheet has a compressive strength (CFD 40%) of about 0.27 Mpa to about 0.35 Mpa measured at 40% of the initial thickness after pressing,
the elastic sheet has a stress relaxation rate of greater than or equal to about 15%, which is a ratio of a stress at 60 seconds after compression under the 70% condition to an initial stress at compression (CFD 70%) under the 70% condition, and
the elastic sheet has a restoring rate of greater than about 70%, which is a ratio of a stress at the time of compression at 40% (CFD 40%) to an initial stress at compression at 40% (CFD 40%) after compression at 70% (CFD 70%).

17. An all-solid-state battery, comprising
a positive electrode,
a negative electrode,
a solid electrolyte layer between the positive electrode and the negative electrode, and
the elastic sheet of claim 12 on an outside of at least one of the positive electrode or the negative electrode.

18. The all-solid-state battery of claim 17, wherein
the all-solid-state battery comprises a stack comprising the positive electrode, the negative electrode, the solid electrolyte layer, and the elastic sheet, and a case accommodating the stack,
wherein the case is pressed with a force in the range of about 400 MPa to about 550 MPa, the elastic sheet is compressed to about 30% to about 60% compared to an initial thickness thereof, and a restoring rate of the elastic sheet is about 35% to about 80% compared to an initial thickness.

19. A method of forming an all-solid-state battery, the method comprising:
forming an all-solid-state battery elastic sheet with the elastic sheet composition according to claim 1.

20. The method of claim 19, further comprising
applying a positive electrode with the elastic sheet;
applying a negative electrode with the elastic sheet;
applying a solid electrolyte layer between the positive electrode and the negative electrode,
the elastic sheet being on an outside of at least one of the positive electrode or the negative electrode; and
accommodating the positive electrode, the negative electrode, the solid electrolyte layer, and the elastic sheet into a case,
wherein the case is pressed with a force in the range of about 400 MPa to about 550 MPa, the elastic sheet is compressed to about 30% to about 60% compared to an initial thickness thereof, and a restoring rate of the elastic sheet is about 35% to about 80% compared to an initial thickness.
